(19) United States
(12) Patent Application Publication
(10) Pub. No.: US 2012/0087286 A1
(43) Pub. Date: Apr. 12, 2012

(54) METHOD FOR TRANSMITTING AN ACK/NACK SYMBOL AND APPARATUS

(75) Inventor: Kyung Ho KIM, San Jose, CA (US)

(73) Assignee: PANTECH WIRELESS, INC., Atlanta, GA (US)

(21) Appl. No.: 12/901,958

(22) Filed: Oct. 11, 2010

(51) Int. Cl. H04W 4/00

(52) U.S. Cl. 370/310

(57) ABSTRACT

A method for transmitting an ACK/NACK symbol includes transmitting a same ACK/NACK symbol in both a first reference symbol and a second reference symbol in a slot. An apparatus to transmit an ACK/NACK symbol includes an ACK/NACK symbol generator, and a transmitter to transmit a modulated first reference symbol modulated by a first ACK/NACK symbol in a first reference symbol long block of a first slot, and to transmit a modulated second reference symbol modulated by the first ACK/NACK symbol in a second reference symbol long block of the first slot. Antenna diversity may be applied in successive slots or between the first and second reference symbols in a slot. A switching pattern to the modulation of the first and/or second reference symbol may be applied.

### BACKGROUND

1. Field of the Disclosure

Exemplary embodiments of the present invention relate to a method for transmitting an ACK/NACK symbol in wireless communications, and an apparatus to transmit an ACK/NACK symbol.

2. Discussion of the Background

In a wireless communication system, a transmitter includes several components for conditioning outgoing data for transmission via the wireless medium. For example, the transmitter may include a modulator to generate complex symbols from the outgoing data, and an inverse Fast Fourier Transfer (IFFT) for converting the complex symbols from the frequency domain into the time domain. Additional processing may occur in the time domain, such as adding a cyclic prefix (CP). Generally, the outgoing signal is upsampled and processed by a is digital-to-analog converter (DAC) to produce an analog signal. This analog signal may be filtered and upconverted in the analog domain to generate a radio frequency (RF) signal to be transmitted into the wireless medium via an antenna.

The 3^{rd} Generation Partnership Project (3GPP) Technical Specifications (TS) incorporate the ACK/NACK concept for confirming successful or unsuccessful receipt and recognition of a message or packet. An ACK represents an acknowledgement by a receiving side that a message or packet sent to the receiving side was received correctly. In this case, the ACK is sent by the receiving side, upon correctly receiving and/or recognizing a message or data, to the transmitting side so that the transmitting side knows whether the data was properly received. If the ACK is not received by the transmitting side within a window after transmitting the message or packet to the receiving side, the transmitting side may determine that the message or packet was not properly received or recognized, and may resend the message or packet to the receiving side. Conversely, a NACK represents a negative acknowledge message by a receiving side, indicating that a message sent to the receiving side was not received correctly or was not recognized by the receiving side. In this case, the NACK is sent by the receiving side so that the transmitting side knows to retransmit the data or message. This may permit the transmitting side to retransmit without having to wait for the window to close before retransmitting. Thus, according to the ACK/NACK concept, the efficiency of the system may depend in part upon efficient transmission and receipt of the ACK and NACK.

The 3GPP TS 36.211 (v9.1.0) describes a physical uplink control channel (PUCCH) as the channel that carries uplink control information from an access terminal to an access point. An access point may be a fixed station or base station to communicate with a wireless terminal, and may be referred to without limitation as an evolved Node B (eNB), or is some other terminology. An access terminal may be referred to without limitation as user equipment (UE), a wireless communication device, terminal, or some other terminology.

The physical uplink control channel supports different formats, including formats 2a and 2b. Format 2a uses a QPSK+BPSK modulation scheme and includes 21 bits per subframe, while format 2b uses QPSK+QPSK modulation scheme and includes 22 bits per subframe. For PUCCH formats 2a and 2b, a cell-specific base sequence is modulated to generate a demodulation reference symbol. Further, according to PUCCH formats 2a and 2b, 3GPP TS 36.211 (v9.1.0) specifies that two PUCCH demodulation reference symbols are included per slot.

FIG. 1 illustrates a conventional structure of a slot according to PUCCH formats 2a and 2b.

Referring to FIG. 1, coded CQI bits are QPSK modulated and the output of the QPSK modulator is sent to a serial-to-parallel converter to split the output into five parallel data paths, respectively carrying complex-valued symbols d₀, d₁, d₂, d₃, and d₄, for example. Complex-valued symbols d₀, d₁, d₂, d₃, and d₄ are each multiplied with a 12-length base sequence r_{U,0} and cyclically-shifted, and the resulting complex symbols are converted from the frequency domain into the time domain through IFFT. As shown in FIG. 1, these parallel data paths are used to generate the OFDM symbols in long blocks (LB) #0, LB #2, LB #3, LB #4, and LB #6. Cyclic prefixes CP are included between each OFDM symbol in the long blocks in a single slot.

Reference Symbol (RS) long blocks are included two per slot in the PUCCH 2a/2b formats, a first RS LB between LB #0 and LB #2, and a second RS LB between LB #4 and LB #6. To form the reference symbols in the RS LB, the 12-length base sequence r_{U,0} is cyclically-shifted, and the complex symbols are converted from the frequency domain into the time domain through IFFT.

According to the Long Term Evolution (LTE) specification, only the second reference symbol in the second RS LB arranged between LB #4 and LB #6 is modulated by an ACK/NACK symbol. The ACK/NACK symbol may be BPSK or QPSK modulated.

Thus, the current application describes a new method for transmitting the ACK/NACK symbols in wireless communications.

### SUMMARY

Exemplary embodiments of the present invention provide a method for transmitting an ACK/NACK symbol as part of Uplink Control Information (UCI), and an apparatus to perform the method.

Additional features of the invention will be set forth in the description which follows, and in part will be apparent from the description, or may be learned by practice of the invention.

An exemplary embodiment of the present invention discloses an apparatus to transmit an ACK/NACK symbol, including an ACK/NACK symbol generator, and a transmitter to transmit a modulated first reference symbol modulated by a first ACK/NACK symbol in a first reference symbol long block of a first slot, and to transmit a modulated second reference symbol modulated by the first ACK/NACK symbol in a second reference symbol long block of the first slot.

An exemplary embodiment of the present invention discloses a method for transmitting an ACK/NACK symbol, including in a first slot, modulating a first reference symbol in a first reference symbol long block by a first ACK/NACK symbol, modulating a second reference symbol in a second reference symbol long block by the first ACK/NACK is symbol, and transmitting the modulated first reference symbol and the modulated second reference symbol in the first slot.

An exemplary embodiment of the present invention discloses a method for transmitting an ACK/NACK symbol, including in a first slot, modulating a first reference symbol in a first reference symbol long block by a first ACK/NACK symbol, not modulating a second reference symbol in a second reference symbol long block by an ACK/NACK symbol, the second reference symbol long block arranged later in the first slot than the first reference symbol long block, and transmitting the modulated first reference symbol and the un-modulated second reference symbol in the first slot.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a conventional structure of UCI format 2a/2b.

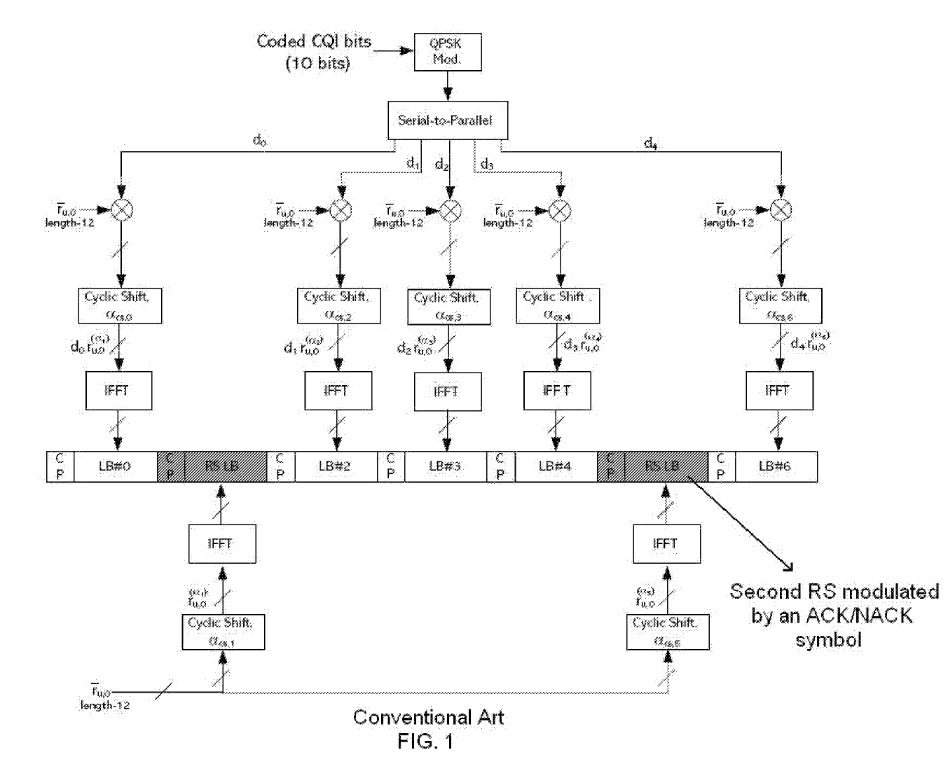

FIG. 2 is a diagram illustrating a structure of UCI format 2a/2b according to an exemplary embodiment of the invention.

FIG. 3 is a diagram illustrating a slot basis pattern of RS modulation by an ACK/NACK symbol according to an exemplary embodiment of the invention.

FIG. 4 is a diagram illustrating a subframe basis pattern of RS modulation by an ACK/NACK symbol according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

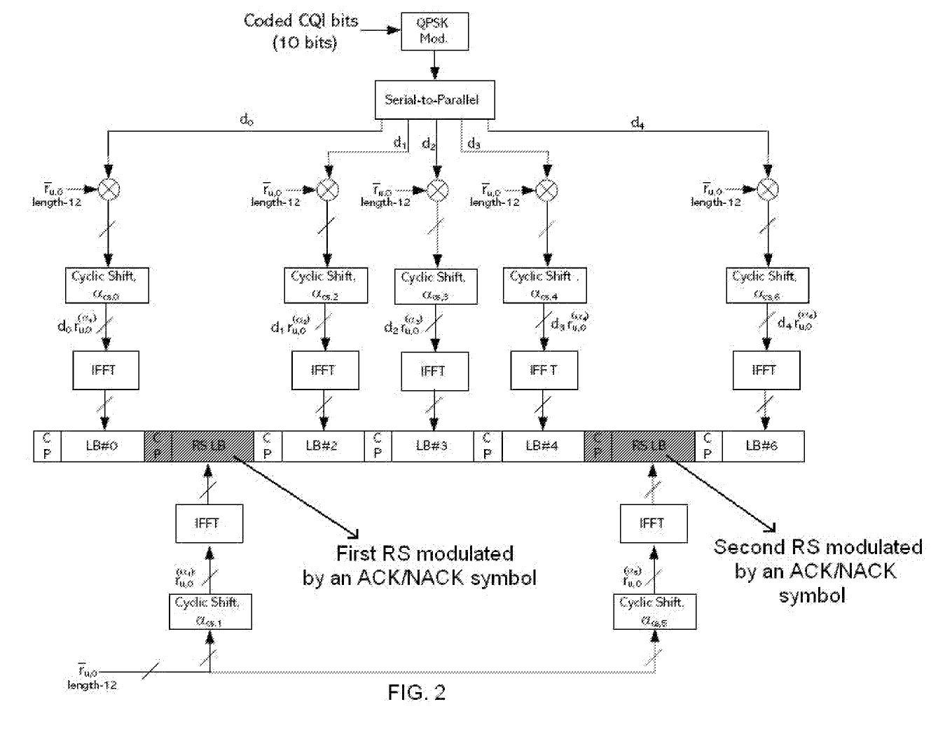

FIG. 2 is a diagram illustrating a structure of UCI format 2a/2b according to an exemplary embodiment of the invention.

If a receiving side that successfully obtains the data signals sent by a transmitting side, such as an access point or base station (referred to generally throughout as “eNB”), the receiving side transmits an acknowledge signal (hereinafter, referred to as “ACK”) to the eNB. Otherwise, a receiving side that does not successfully receive or recognize a data signal sent by an eNB transmits a negative acknowledge signal (hereinafter, referred to as “NACK”) to the eNB.

Referring to FIG. 2, according to an exemplary embodiment, both a first and second reference symbol (RS) respectively and sequentially arranged in the first and second RS LBs of a slot are modulated by an ACK/NACK symbol. The ACK/NACK symbol that is used to modulate both the first RS and the second RS could be the same ACK/NACK symbol.

If the first RS and the second RS are both modulated by the same ACK/NACK symbol in a single slot, there may be detectable advantages for improving the probability of successful receive of the ACK/NACK symbol by the eNB. First, since the first RS and the second RS are sent at different times in the slot, the time diversity of sending the same ACK/NACK symbol at different times may increase probability of successful receipt of the ACK/NACK symbol by the eNB. For example, if a second RS is corrupted in successive slots, the ACK/NACK symbol in the second RS may not be well-detected by the eNB. Therefore, the first RS containing the ACK/NACK symbol may be better detected by the eNB. Second, there may be an advantage through repetition gain since the same information, i.e. the same ACK/NACK symbol, could be received by a transmitting side and could be combined together to better confirm the data transmitted in the ACK/NACK symbol.

Further, other embodiments may be implemented. For example, antenna switching is disclosed according to reference symbol signal-to-interference-and-noise ratio (SINR). In the antenna switching, the eNB could establish a pattern for transmitting using a first antenna only, a second antenna only, or both first and second antenna by a diversity mobile terminal including two transmit antennas.

A modulation switching pattern could be implemented. For example, the eNB could configure a pattern for modulating the first RS only, the second RS only, or both the first and second RSs with the ACK/NACK symbol per slot. The pattern could be established as a predetermined pattern, or could be flexibly configured according to a trend of SINR of the first RS symbol relative to SINR of the second RS symbol.

Also, there may be a switching pattern for one or both of the antenna-switching and RS-switching to exploit both the antenna diversity and time diversity, which may improve the diversity gain. For example, the first RS and the second RS may be both modulated by the same ACK/NACK symbol in a slot. Further, the first RS and the second RS may be both sent via only a first antenna (F) in a diversity mobile terminal in a first slot. In a second slot after the first slot, the first RS and the second RS may be both sent via only a second antenna (S) in the diversity mobile terminal. Thus, a pattern may be established for using either the first (F) or the second (S) antenna to transmit both the first RS and the second RS per slot, for example FSFSFS or SSSFFSSS. In this case, demodulation reference could be provided by, for example, not allowing the ACK/NACK modulation of the RS(s) of a next slot in a subframe, or slots of a next subframe depending on the channel condition.

By applying a switching pattern to the modulation of the first RS and the second RS with the ACK/NACK symbol, a pattern may be established for using either the first (F) RS or the second (S) RS to transmit the ACK/NACK symbol per slot, for example FSFSFS or SSSFFSSS.

Further, the antenna switching scheme may be incorporated into the first/second RS switching pattern. For example, in the patterns established for using either the first (F) RS or the second (S) RS to transmit the ACK/NACK symbol per slot, for example FSFSFS or SSSFFSS, each slot may be sent using only the first antenna, only the second antenna, or both the first and second antennas according to an antenna switching pattern.

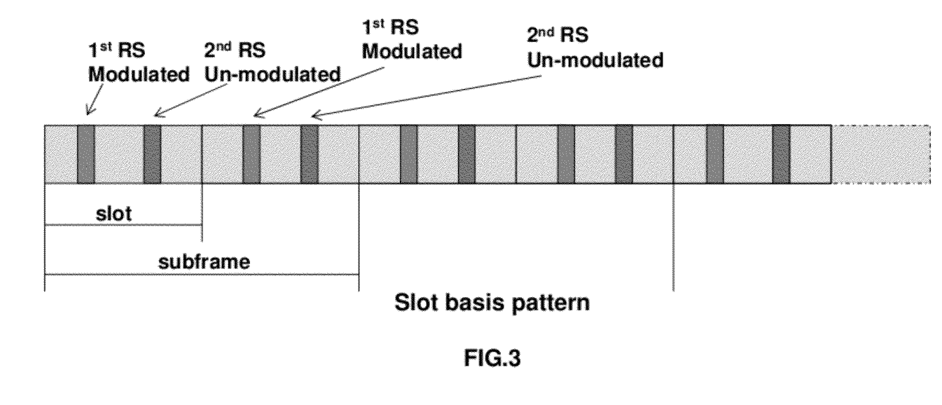

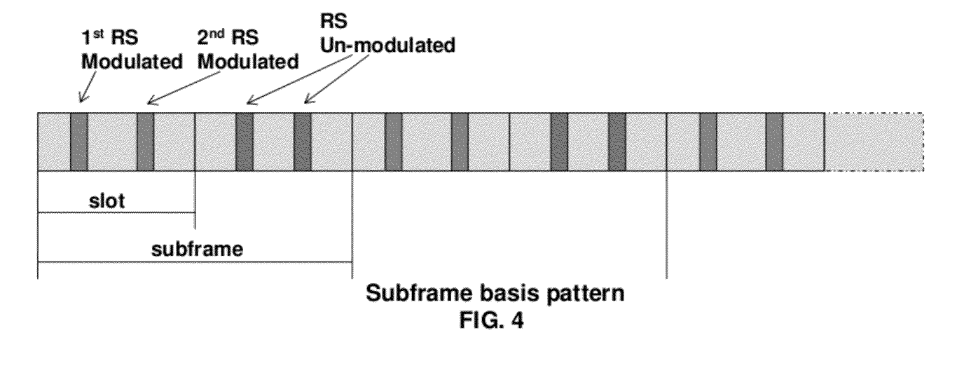

The granularity of the pattern could be on a slot basis, or a subframe basis, such as shown in FIG. 3 and FIG. 4, and described below. The granularity of the pattern could depend on the channel condition.

Further, orthogonal cover codes (OCC) may be applied to the first RS and the second RS. This may provide orthogonality for the ACK/NACK modulated RS symbols and may provide a greater chance that the ACK/NACK symbols will be properly received and understood by the eNB.

FIG. 3 is a diagram illustrating a slot basis pattern of RS modulation by an ACK/NACK symbol according to an exemplary embodiment of the invention.

Referring to FIG. 3, a first RS in a first slot of a subframe is modulated by an ACK/NACK symbol. A second RS in the first slot of the subframe is not modulated by an ACK/NACK symbol, however. In a second slot of the subframe, a first RS is modulated by an ACK/NACK symbol, and a second RS is not modulated by an ACK/NACK symbol. Thus, only a first RS in each slot of a two-slot subframe is modulated by an ACK/NACK symbol. As explained above, a transmitting antenna diversity scheme could also be incorporated into this pattern.

FIG. 4 is a diagram illustrating a subframe basis pattern of RS modulation by an ACK/NACK symbol according to an exemplary embodiment of the invention.

Referring to FIG. 4, a first RS in a first slot of a subframe is modulated by an ACK/NACK symbol. A second RS in the first slot of the subframe is also modulated by the ACK/NACK symbol. The ACK/NACK symbol used to modulate both the first RS and the second RS may be the same ACK/NACK symbol. In a second slot of the subframe, both the first RS and the second RS of the second slot are not modulated by an ACK/NACK symbol. Thus, both a first RS and a second RS in a first slot of the subframe are modulated by an ACK/NACK symbol, and neither a first RS nor a second RS in second slot of the subframe are modulated by an ACK/NACK symbol according to this embodiment. As explained above, a transmitting antenna diversity scheme could also be incorporated into this pattern.

The method for transmitting the ACK/NACK according to the above-described exemplary embodiments of the present invention may be recorded in computer-readable media including program commands to implement various operations embodied by a computer. The media may also include, alone or in combination with the program commands, data files, data structures, and the like. Examples of computer-readable media include magnetic media such as hard disks, floppy disks, and magnetic tape; optical media such as CD-ROM disks and DVDs; magneto-optical media such as optical disks; and hardware devices that are specially configured to store and perform program commands, such as read-only memory (ROM), random access memory (RAM), flash memory, and the like. Examples of program commands include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to transmit an ACK/NACK symbol, comprising:
an ACK/NACK symbol generator; and
a transmitter to transmit a modulated first reference symbol modulated by a first ACK/NACK symbol in a first reference symbol long block of a first slot, and to transmit a modulated second reference symbol modulated by the first ACK/NACK symbol in a second reference symbol long block of the first slot.

2. The apparatus of claim 1, wherein the apparatus is a diversity mobile terminal comprising:
a first transmitting antenna and a second transmitting antenna,
wherein the modulated first reference symbol is transmitted by only the first transmitting antenna, only the second transmitting antenna, or both the first transmitting antenna and the second transmitting antenna in the first slot, and
the modulated second reference symbol is transmitted by only the first transmitting antenna, only the second transmitting antenna, or both the first transmitting antenna and the second transmitting antenna in the first slot.

3. The apparatus of claim 2, wherein in a second slot, a modulated first reference symbol is transmitted by only the first transmitting antenna.

4. A method for transmitting an ACK/NACK symbol, comprising:
in a first slot,
modulating a first reference symbol in a first reference symbol long block by a first ACK/NACK symbol;
modulating a second reference symbol in a second reference symbol long block by the first ACK/NACK symbol; and
transmitting the modulated first reference symbol and the modulated second reference symbol in the first slot.

5. The method of claim 4, further comprising:
in a second slot,
not modulating a first reference symbol in a first reference symbol long block by an ACK/NACK symbol;
not modulating a second reference symbol in a second reference symbol long block by an ACK/NACK symbol; and
transmitting the un-modulated first reference symbol and the un-modulated second reference symbol in the second slot.

6. The method of claim 4, further comprising:
in a second slot,
modulating a first reference symbol in a first reference symbol long block by a second ACK/NACK symbol;
modulating a second reference symbol in a second reference symbol long block by the second ACK/NACK symbol; and
transmitting the modulated first reference symbol and the modulated second reference symbol in the second slot.

7. The method of claim 4, wherein transmitting the modulated first reference symbol and the modulated second reference symbol in the first slot comprises:
transmitting the modulated first reference symbol by a first transmitting antenna, and transmitting the modulated second reference symbol by a second transmitting antenna in the first slot.

8. The method of claim 4, wherein the modulated first reference symbol is transmitted by only a first transmitting antenna, only a second transmitting antenna, or both the first transmitting antenna and the second transmitting antenna of a diversity mobile terminal.

9. The method of claim 4, wherein the modulated second reference symbol is transmitted by only a first transmitting antenna, only a second transmitting antenna, or both the first transmitting antenna and the second transmitting antenna of a diversity mobile terminal.

10. A method for transmitting an ACK/NACK symbol, comprising:
in a first slot,
modulating a first reference symbol in a first reference symbol long block by a first ACK/NACK symbol;
not modulating a second reference symbol in a second reference symbol long block by an ACK/NACK symbol, the second reference symbol long block arranged later in the first slot than the first reference symbol long block; and
transmitting the modulated first reference symbol and the un-modulated second reference symbol in the first slot.

11. The method of claim 10, further comprising:
in a second slot,
not modulating a first reference symbol in a first reference symbol long block by an ACK/NACK symbol;
modulating a second reference symbol in a second reference symbol long block by a second ACK/NACK symbol; and
and transmitting the un-modulated first reference symbol and the modulated second reference symbol in the second slot.

12. The method of claim 11, wherein the modulated second reference symbol is transmitted by only a first transmitting antenna, only a second transmitting antenna, or both the first transmitting antenna and the second transmitting antenna of a diversity mobile terminal.

13. The method of claim 10, wherein the modulated first reference symbol is transmitted by only a first transmitting antenna, only a second transmitting antenna, or both the first transmitting antenna and the second transmitting antenna of a diversity mobile terminal.
